(19) United States
(12) Patent Application Publication
(10) Pub. No.: US 2006/0007666 A1
(43) Pub. Date: Jan. 12, 2006

(54) Light modifier

(76) Inventor: Kenneth O. Cook, Salinas, CA (US)

Correspondence Address: EMCH, SCHAFFER, SCHAUB & PORCELLO CO, P O BOX 916, ONE SEAGATE SUITE 1980, TOLEDO, OH, 43697, US

(21) Appl. No.: 10/887,463

(22) Filed: Jul. 8, 2004

(51) Int. Cl. G03B 15/02

(52) U.S. Cl. 362/16; 362/351; 362/355

(57) ABSTRACT

A light modifier for creating an enhanced depth of lighting on a subject. The light modifier has a housing with a sidewall that defines a first and second end. The first and second ends are in opposed relationship. The first end is adapted to mount a light source in the housing. A panel is positioned on the second end of the housing. The panel has at least one layer of netting having an aperture. Light that passes through the netting has different characteristics than the light passing through the aperture whereby the light modifier creates enhanced depth of lighting on a subject.

This invention relates to improvements to a light modifier that is used to modify light from a light source. The light modifier is used by photographers and image makers to modify the light that is presented to a subject or an image to create the desired depth of field and shadowing.

### BACKGROUND OF THE INVENTION

Light modifiers have been used in the photography industry for quite some time. A well-known example is light diffusion boxes, which have been used by photographers and others to defuse or soften the lighting on a subject. These diffusion boxes have an outer housing with a light source at one end and a diffusion panel at the other end through which the light from the light source must pass before striking the subject. This type of light modifier has been focused on obtaining a uniform quality to the light that is presented on the subject that is to be photographed. These light boxes can be collapsible in nature or have a fixed outer structure. However, all of these prior light boxes are trying to achieve a uniform distribution of light on the subject that is to be photographed or otherwise captured.

### SUMMARY OF THE INVENTION

The present invention is directed to a light modifier having a collapsible outer housing with a light source mounted on one end with a panel positioned on the other end of the outer housing in an opposed relationship to the light source. However, the light modifier of the present invention is not directed to achieving a uniform quality for the light produced from the light source. The panel that is placed across the end of the outer housing has a hole or aperture in the center that allows at least some of the light from the light source to pass through the panel without being modified or diffused by the panel. The panel can have several layers and the aperture or hole in the center of the layers can vary in size whereby the light from the light source is modified or diffused at different levels across the face of the panel. It is the intent of the present invention to produce a lighting and shadowing effect on the subject that is similar to the lighting patterns utilized by the old masters in their oil paintings. The lighting patterns that make these paintings unique and desirable vary across the subject that is being painted and produce dramatic characteristics for these paintings.

It is an object of the present light modifier to replicate the lighting patterns and characteristics utilized by the old masters in their master piece oil paintings.

These and other objects and advantages of the invention will be more fully understood by reference to the following written description and the accompanying drawings.

### BRIEF DESCRIPTION OF THE DRAWINGS

FIG. 1 is a perspective view of the light modifier of the present invention;

FIG. 2 is a perspective view of the light modifier;

FIG. 3 is a front elevation view of the housing of the light modifier;

FIG. 4 is a perspective view of the housing of the light modifier;

FIG. 5 is a perspective view of a portion of the housing; and

FIG. 6 is a cross sectional view taken along line 6-6 in FIG. 3.

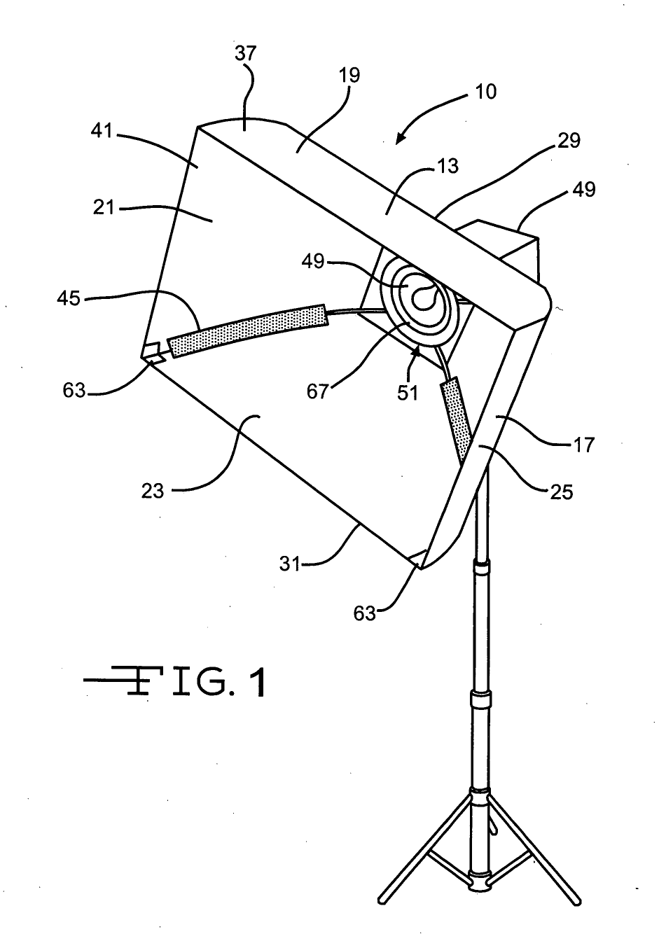

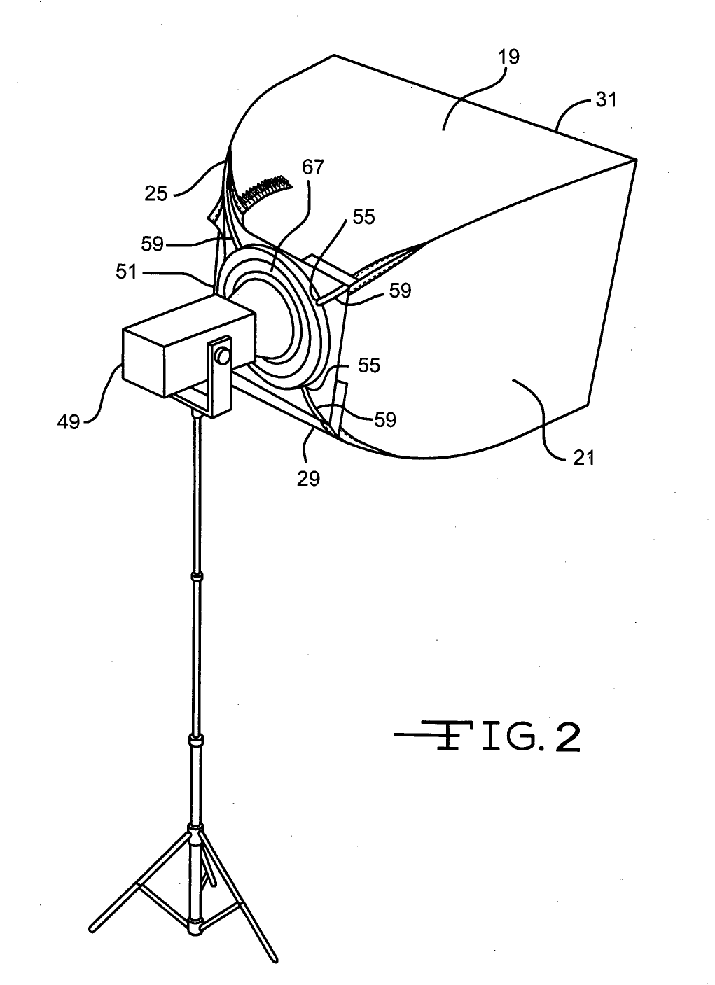

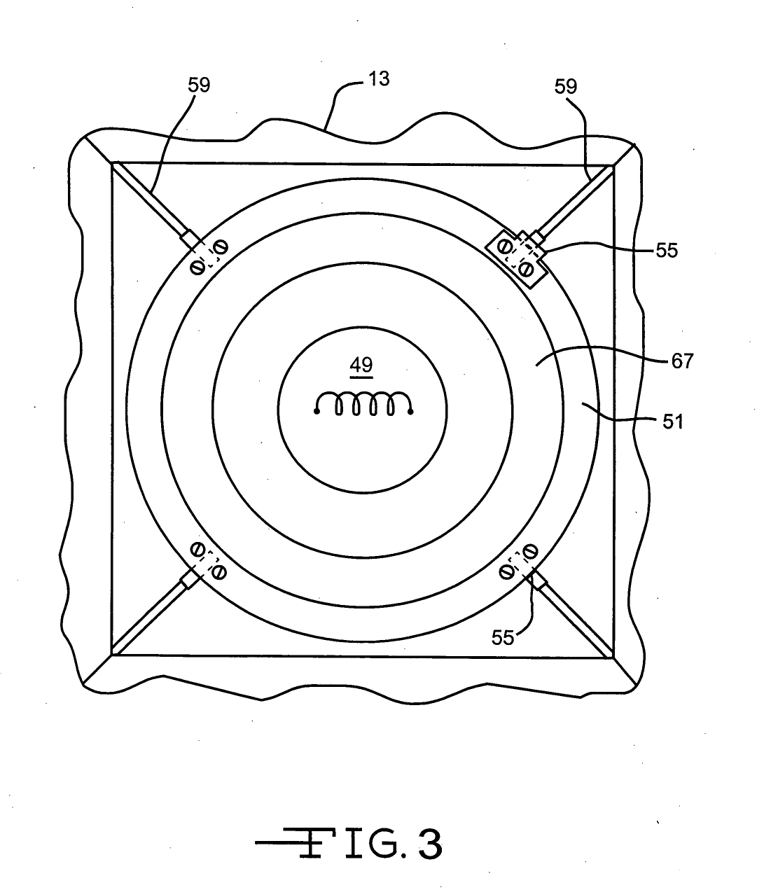

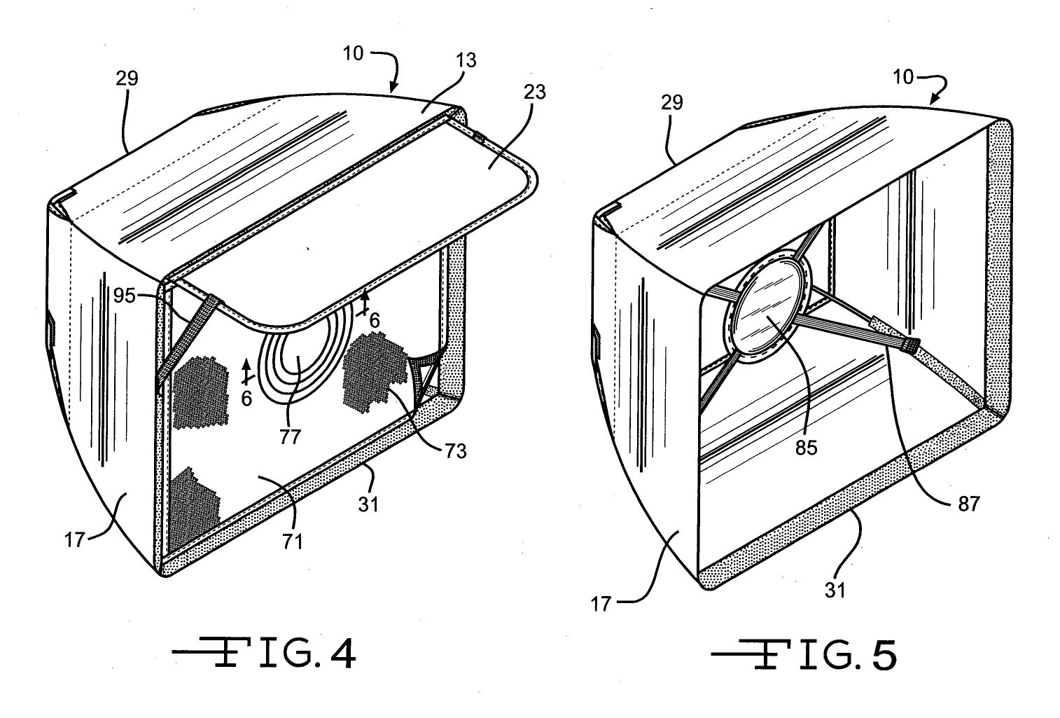

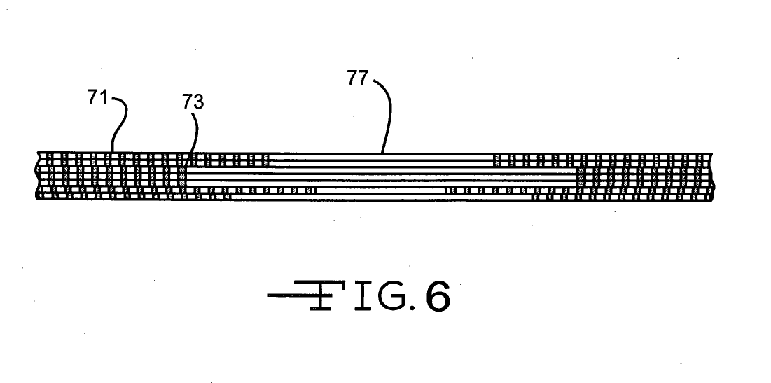

### DETAILED DESCRIPTION OF THE PREFERRED EMBODIMENT

The invention is directed to a light modifier that is used to provide lighting for a subject. More particularly, the light modifier modifies the characteristics of light from a light source to create enhanced depth of lighting on a subject or image that is being photographed, video taped or captured on film. The features of the invention will be more readily understood by referring to the attached drawings in combination with the following description.

The light modifier 10 has a collapsible housing 13 that defines a sidewall 17. The sidewall 17 is usually formed of a four separate panels 19, 21, 23 and 25 respectively that are joined together to form the sidewall 17 of the collapsible housing 13. The panels of the sidewall 17 are generally trapezoidal in shape and are made of a fabric material. The fabric panels 19, 21, 23, and 25 are assembled to form the sidewall 17 of the housing so that the housing 13 defines a first end 29 and a second end 31. The panels 19, 21, 23 and 25 are usually formed of a fabric material having an outer layer 37 and an inner layer 41. The outer layer 37 of fabric is typically black and is opaque to light that is contained within the housing 13. The inner layer of fabric is typically reflective in nature and the inner layer 41 of fabric forms the interior of the collapsible housing 13. A loop or passageway 45 is formed in the inner layer 41 of fabric along at least a portion of the edges where the panels 19, 21, 23 and 25 are joined together to form the sidewall 17. Normally the passageways 45 are created by sewing in an additional layer of fabric that forms the inner layer 41 to create the passageway. However, other methods can be utilized to form the passageways in the interior of the collapsible housing 13.

The first end 29 of the housing 13 is adapted to receive a light source 49 and a cylindrical fixture 51 is positioned in the first end 29 for removably receiving the light source 49. The cylindrical fixture 51 has 4 holes 55 positioned in the outer perimeter of the cylindrical fixture. The holes 55 are spaced equidistantly from each other around the outer periphery of the cylindrical fixture 51 so that the holes 55 are in alignment with the four seams where the panels 19, 21, 23 and 25 are joined together to form the collapsible housing 13. A flexible rod 59 can be positioned in each of the holes 55 so that the rods extend from the cylindrical fixture 51. The flexible rod 59 can be positioned in the passageways 45 formed in the sidewall 17 of the housing 13. The flexible rods 59 provide a support structure that is suitable to support the panels 19, 21, 23 and 25 in a manner to form the collapsible housing 13 of the light modifier 10. In some applications, it is desirable to have a pocket 63 formed in the panels 19, 21, 23 and 25 to receive the ends of the flexible rods 59. The pocket 63 can be formed as part of the passageways 45 or they can be formed as a separate element. The pocket 63 are normally positioned adjacent the second end 31 of the housing 13. Suitable adaptors 67 can be utilized with the cylindrical fixture 51 to secure a light source 49 to the light modifier 10. The adaptor 67 allow the light source to be mounted so that the light source is positioned in the interior of the collapsible housing 13 or at least directs the light produced by the light source into the interior of the collapsible housing 13.

A panel 71 is removablly secured to the second end 31 of the collapsible housing 13. The panel 71 can be held in place by hook and loop type fasteners or other suitable securing means. The panel 71 is formed of at least one layer of netting 73 having an aperture 77 located essentially in the center of the panel 71. The layer of netting 73 acts to diffuse or modify the light that it receives from the light source 49 and the aperture 77 does not modify or diffuse the light that it receives from the light source 49. Accordingly, the light modifier 10 can create an enhanced depth of field for the lighting that is used to illuminate a subject. The panel 71 can have several layers of netting 73 to create a larger variation between the light passing through the netting and the light passing through the apertures 77 in the center of the layers of netting. In practice it has been found that between 1 and 20 layers of netting can be used to form the panel 71. Examples of netting that are particularly useful are cotton, nylon, polyester or similar fabric netting having the ability to withstand high heat applications. In particular, a cotton bobbin net with round holes has been found to work effectively as the netting 73 that forms the panel 71. Netting is used to form the panel 71 as the netting has a plurality of openings that alter the density of the light from the light source 49 but does not change the quality of the light from the light source. The quality of the light refers to the specular nature of the light and is directly related to the clarity or sharpness of the light. Woven or knit textile diffusion type of fabrics are not preferable for the panel 71 as such fabrics change the quality of the light in addition to altering the density of the light. The netting is also usually black in color as the black fabric portion of the netting absorbs or blocks a portion of the light from the light source 49 and reduces the density of the light from the light source. Other colors can be used for the netting but other colors are not as effective as black in reducing the density of the light from the light source 49. As more layers of netting are used to form the panel 71, there will be a layer reduction in the density of the light from the light source that passes through the panel 71, as there will be more fabric present to absorb the light. The aperture 77 formed in the layers of netting 73 can have the same diameter and location in the layers of netting or the diameters of the apertures can vary between the individual layers of netting 78 to form the panel 71. However, it is usually desirable to have the apertures 77 have a common center point and be concentrically positioned in the panel 71. Although the apertures 77 have been shown as being circular in shape it should be understood that other geometric shapes could be used to form the apertures and as such other geometric would change the pattern of the lighting that is presented to the subject. It is also possible to utilize apertures in the panel 77 that have different geometric shapes in some or all of the layers of netting that form the panel.

In applications where multiple layers of netting 73 are used to form the panel 71 it is possible to create different levels of diffusion or modification for the light by increasing the size of the apertures 77 in the various layers of netting. If different sized aperture 77 are utilized the light from the light source will pass through more layers of netting as the light moves away from the center of the panel 71 to the outer periphery of the panel 71. The light closer to the center of the panel 71 will pass through fewer layers of netting and therefore receive less diffusion or modification than the light around the outer periphery of the panel 71. The light passing through the open aperture 77 formed in the center of the panel 71 will not be diffused or modified by the panel and will have a different impact on the subject. The number of layers of netting 73 and the size and shape of the aperture 77 can be selected to produce the desired lighting effect on the subject. In FIG. 6 the aperture 77 in the layers of netting 73 are shown as being randomly spaced. However, in practice it has been found to be desirable to have the layers of netting 73 that form the panel 71 be positioned so that the aperture 77 are progressively larger or smaller as light from the light source 49 moves through the panel 71.

To further modify the light from the light source 49 is possible to position a removable baffle 85 in the interior of the collapsible housing 13. The removable baffle 85 is positioned in the interior of the housing so that the light from the light source 49 must pass through the baffle before engaging the panel 71 on the second end 31 of the housing 13. As shown in the drawings the removable baffle is a circular piece of fabric that is connected to the sidewall 17 of the housing 13 by resilient straps 87. The resilient straps can be removably secured to the sidewall 17 by loop and hook type fastening means or other suitable releasable securing means. The fabric for the removable baffle can be white nylon or other suitable fabric that can be used to diffuse the light from the light source 49. Although the removable baffle 85 has been shown as being circular in shape it should be appreciated that other geometric shapes can be used for the baffle. The baffle can also be positioned at different locations within the housing 13 with respect to the light source 49 to alter the diffusion that is created by the baffle 85. In most applications, the baffle 85 is configured and positioned to diffuse the light that passes through the aperture 77 in the panel 71. However, if different light patterns are desired the baffle 85 can be of a shape or size to impact or diffuse more or less than the light that passes through the aperture 77.

Spill light panels 93 can be removably secured to the second end 31 of the housing 13. The spill light panels are formed of a fabric material that is usually similar to the fabric utilized for the outer layer 37 of the panels 19, 21, 23 and 25 that form the sidewall 17 of the housing 13. The spill light panels 93 can be positioned at the end of each panel 19, 21, 23 and 25 that form the second end 31 of the housing 13. Alternatively, the spill light panels can only be secured to a portion of the panels that form the sidewall 17. The spill light panels are movably positioned on the housing 13 so that the spill light panels can be moved to cover a portion of the panel 71 located on the second end 31 of the housing 13. The spill light panels 93 cover the portion of the panel 71 that forms the outer periphery of the light modifier 10. The spill light panels 93 are held in the desired position with respect to the panel 71 by straps 95 that secure to the panels 19, 21, 23 and 25. The straps 95 can be secured to the panels by hook and loop type fasteners or other suitable fastening means.

I claim:

1. A light modifier for lighting a subject comprising:
a housing having a sidewall; the housing having a first end and a second end, the first and second ends being in opposed relationship, the first end adapted to mount a light source in the housing, a panel positioned on the second end of the housing, the panel having at least one layer of netting having an aperture whereas light from the light source passing through at least one layer of netting has different characteristics than the light passing through the aperture whereas the light modifier creates enhanced depth of lighting on a subject.

2. The light modifier of claim 1 wherein the panel has a plurability of layers of netting.

3. The light modifier of claim 2 wherein the aperture is in the center of each of the panels.

4. The light modifier of claim 3 wherein the layers of netting have different size apertures whereby there are more layers of netting that impact the light generated by the light source at the perimeter of the panel than in the center of the panel.

5. The light modifier of claim 4 wherein the layers of netting increase in a uniform manner from the center aperture to the perimeter of the panel.

6. The light modifier of claim 1 wherein an interior baffle is positioned between the first and second ends of the housing, the baffle acting to diffuse light from a light source before the light reaches the second end of the housing.

7. The light modifier of claim 6 wherein the baffle is white nylon fabric that diffuses the light from a light source.

8. The light modifier of claim 7 wherein the baffle is removable positioned in the housing.

9. The light modifier of claim 7 wherein the baffle is circular in shape and is sized to diffuse all of the light projected from a light source that passes through the aperture in the panel.

10. The light modifier of claim 5 wherein the apertures in the layers of netting are positioned concentrically in the layers of netting.

11. The light modifier of claim 1 wherein at least one layer of netting is made of a fabric selected from the group of nylon, polyester or cotton.

12. The light modifier of claim 1 wherein the at least one layer of netting is a cotton bobbin net material having the characteristics that allow the material to be used in high heat applications.

13. The light modifier of claim 12 wherein the cotton bobbin net material has round holes.

14. The light modifier of claim 1 wherein at least one spill light panel is moveably positioned on the second end of the housing and can be positioned to cover a portion of the panel to create different light patterns.

15. The light modifier of claim 14 wherein the spill light panel is made of a dark fabric.

16. The light modifier of claim 1 wherein the at least one layer of netting is made from a black fabric.
